(19) United States
(12) Patent Application Publication
(10) Pub. No.: US 2012/0050943 A1
(43) Pub. Date: Mar. 1, 2012

(54) METHOD OF MANUFACTURING ELECTRODE FOR ELECTROCHEMICAL CAPACITOR AND ELECTROCHEMICAL CAPACITOR MANUFACTURED USING THE SAME

(75) Inventors: Hak Kwan KIM, Gyeonggi-do (KR); Bae Kyun Kim, Gyeonggi-do (KR); Hong Seok Min, Gyeonggi-do (KR); Dong Hyeok Choi, Gyeonggi-do (KR)

(73) Assignee: SAMSUNG ELECTRO-MECHANICS CO., LTD.

(21) Appl. No.: 13/219,227

(22) Filed: Aug. 26, 2011

(30) Foreign Application Priority Data
Aug. 27, 2010 (KR) 10-2010-0083378

(51) Int. Cl. H01G 9/04; H01G 9/00

(52) U.S. Cl. 361/500; 29/25.03

(57) ABSTRACT

Provided are a method of manufacturing an electrode for an electrochemical capacitor and an electrochemical capacitor manufactured using the same. The method of manufacturing an electrode for an electrochemical capacitor includes immersing a metal foil in an acid solution to form a porous current collector having a skeleton structure with a surface roughness, applying an active material on the porous current collector, and pressing the porous current collector including the active material to distribute the active material into the porous current collector.

### CROSS-REFERENCE TO RELATED APPLICATIONS

This application claims the benefit of Korean Patent Application No. 10-2010-0083378 filed with the Korea Intellectual Property Office on Aug. 27, 2010, the disclosure of which is incorporated herein by reference.

### BACKGROUND OF THE INVENTION

1. Field of the Invention

The present invention relates to an electrochemical capacitor, and more particularly, to a method of manufacturing an electrode for an electrochemical capacitor for forming a porous current collector formed of a skeleton structure having a surface roughness and an electrochemical capacitor manufactured using the same.

2. Description of the Related Art

Electrochemical capacitors have been attracting attention as high quality energy sources in a renewable energy system that can be applied to electric vehicles, hybrid vehicles, fuel cell vehicles, heavy equipment, mobile electronic terminals, and so on. Such electrochemical capacitors are referred to as various names such as supercapacitors and ultra capacitors.

Electrochemical capacitors may be classified into electrical double layer capacitors using an electrical double layer theory, and hybrid supercapacitors using electrochemical oxidation-reduction reaction. Here, while the electrical double layer capacitors are widely used in fields that require high-output energy characteristics, they have a problem such as a small capacity. On the other hand, the hybrid supercapacitors have been widely researched as new alternatives to improve capacitive characteristics of the electrical double layer capacitors. In particular, a lithium ion capacitor (LIC) among the hybrid supercapacitors may have a storage capacity three to four times larger than that of the electrical double layer capacitors.

Meanwhile, such an electrochemical capacitor may include an electrode cell in which two electrodes are alternately laminated with separators interposed therebetween, a housing for containing the electrode cell, and an electrolyte contained in the housing in which the electrode cell is contained.

Here, the electrode may include a metal foil, and an active material layer formed by applying slurry including an active material, a conductive material and a binder. At this time, in order to increase bonding strength between the metal foil and the active material layer, since the electrode requires a large amount of binder, a contact resistance between the current collector and the active material layer is increased and a thickness of the electrode is also increased. As a result, a rate of utilization of the active material and cycle lifespan characteristics may be limited to decrease charge/discharge characteristics and lifespan of the electrochemical capacitor.

Therefore, a technique of manufacturing a novel electrode for improving charge/discharge characteristics and lifespan of the electrochemical capacitor is needed.

### SUMMARY OF THE INVENTION

The present invention has been invented in order to overcome the above-described problems and it is, therefore, an object of the present invention to provide a method of manufacturing an electrode for an electrochemical capacitor for forming a porous current collector formed of a skeleton structure having a surface roughness and an electrochemical capacitor manufactured using the same.

In accordance with one aspect of the present invention to achieve the object, there is provided a method of manufacturing an electrode for an electrochemical capacitor, which includes: immersing a metal foil in an acid solution to form a porous current collector having a skeleton structure with a surface roughness; applying an active material on the porous current collector; and pressing the porous current collector including the active material to distribute the active material into the porous current collector.

Here, the acid solution may include different kinds of acids.

In addition, the acid solution may include a mixed solution of sulfuric acid and hydrochloric acid.

Further, the sulfuric acid and hydrochloric acid may be mixed at a ratio of 1:1 to 3:1.

Furthermore, the acid solution may include a mixed solution of hydrochloric acid and nitric acid.

In addition, the hydrochloric acid and nitric acid may be mixed at a ratio of 1:1 to 3:1.

Further, the method of manufacturing an electrode for an electrochemical capacitor may further include, after immersing the metal foil in the acid solution to form the porous current collector having the skeleton structure with a surface roughness, a cleaning process of removing the acid solution adsorbed to the porous current collector, and a dry process of removing a cleaning solution.

Furthermore, the method of manufacturing an electrode for an electrochemical capacitor may further include, after pressing the porous current collector including the active material to distribute the active material into the porous current collector, forming a terminal at one side of the porous current collector.

In addition, forming the terminal at one side of the porous current collector may be performed by welding.

Further, the active material may include active material particles, a conductive material, a binder and solvent.

In accordance with another aspect of the present invention to achieve the object, there is provided an electrochemical capacitor including cathodes and anodes alternately laminated with separators interposed therebetween, wherein the cathode comprises a porous cathode current collector and a cathode active material filled in the porous cathode current collector, and a skeleton that forms the porous cathode current collector has a surface roughness.

Here, the electrochemical capacitor may further include a cathode terminal connected to the cathode current collector by welding.

In addition, the anode may include an anode current collector and anode active material layers disposed on both surfaces of the anode current collector.

Further, the electrochemical capacitor may further include an anode terminal extending from one side of the anode current collector.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a photograph of an electrode for an electrochemical capacitor in accordance with a first exemplary embodiment of the present invention;

FIG. 2 is an enlarged view of a region A of FIG. 1;

FIG. 3 is an enlarged view of a region B of FIG. 2;

FIGS. 4 to 8 are cross-sectional views for explaining a method of manufacturing an electrode for an electrochemical capacitor in accordance with a first exemplary embodiment of the present invention; and

FIG. 9 is a cross-sectional view of an electrochemical capacitor in accordance with a second exemplary embodiment of the present invention.

### DETAILED DESCRIPTION OF THE PREFERABLE EMBODIMENTS

Hereinafter, embodiments of the present invention for an electrochemical capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

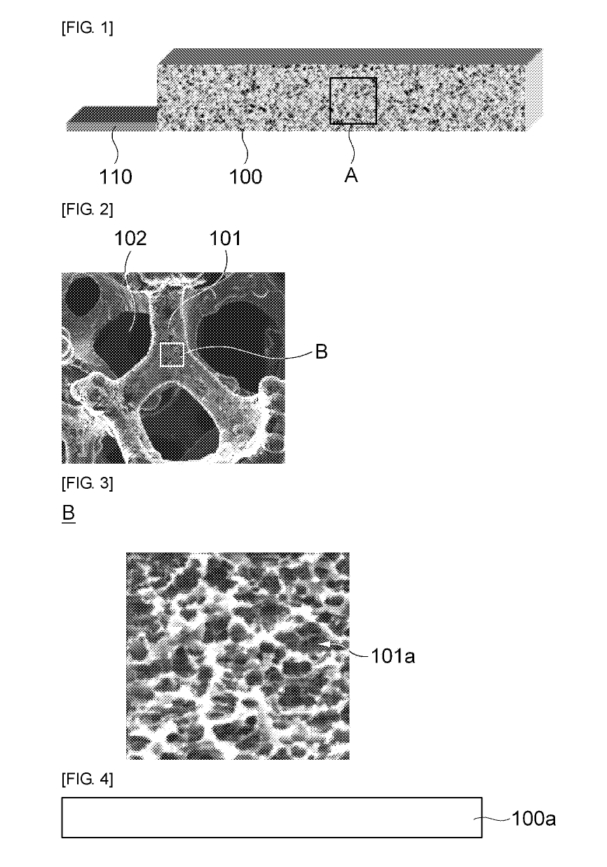

FIG. 1 is a photograph of an electrode for an electrochemical capacitor in accordance with a first exemplary embodiment of the present invention.

FIG. 2 is an enlarged view of a region A of FIG. 1.

FIG. 3 is an enlarged view of a region B of FIG. 2.

Referring to FIGS. 1 to 3, an electrode 100 for an electrochemical capacitor in accordance with a first exemplary embodiment of the present invention may include a porous current collector and an active material distributed in the porous current collector.

Here, the porous current collector may have a plurality of pores 102. Here, the active material is filled in the pores 102 to increase a bonding area between the porous current collector and the active material, increasing conductivity of the electrode and reducing a resistance between the porous current collector and the active material.

In addition, as the bonding area between the porous current collector and the active material is increased, bonding strength between the porous current collector and the active material can be increased. Therefore, since the electrode 100 can be formed while reducing a content of the binder in comparison with the conventional art, and a contact resistance between the porous current collector and the active material can be further reduced, an electrode capacity and high efficiency charge/discharge characteristics can be further improved. In addition, since the content of the binder in the active material can be reduced, a rate of utilization of the active material particles can be increased and high output and energy density can be obtained.

Here, the active material is bonded to the skeleton structure 101 that forms the porous current collector. The active material may be separated from the skeleton structure 101 due to repeated charge/discharge cycles of the electrochemical capacitor to reduce the lifespan of the electrochemical capacitor.

At this time, in order to increase bonding strength between the skeleton structure 101 and the active material, a surface roughness 101a is formed at the skeleton structure 101 to increase the bonding strength between the skeleton structure 101 and the active material. Therefore, the bonding strength between the porous current collector and the active material can be further increased to prevent the active material from being seceded from the skeleton structure 101 due to the repeated charge/discharge cycles of the electrochemical capacitor, improving lifespan characteristics of the electrochemical capacitor.

The electrode may include a terminal 110 to be connected to an external power source. Here, the terminal 110 may be bonded to one side of the porous current collector of the electrode 100 by welding.

Therefore, as described in the first embodiment of the present invention, since the skeleton structure that forms the porous current collector has a surface roughness, a bonding area between the porous current collector and the active material can be increased to further improve a rate of utilization of the active material and cycle lifespan characteristics.

In addition, since the active material of the electrode for an electrochemical capacitor in accordance with an exemplary embodiment of the present invention is permeated in the current collector, even when the same or larger capacity is provided in comparison with the conventional art, it is possible to further reduce the thickness of the electrode than the case of forming the electrode by forming the active material layer on the current collector.

FIGS. 4 to 8 are cross-sectional views for explaining a method of manufacturing an electrode for an electrochemical capacitor in accordance with a first exemplary embodiment of the present invention.

Referring to FIG. 4, in order to form an electrode for an electrochemical capacitor in accordance with a first exemplary embodiment of the present invention, first, a metal foil 100a is provided to form a porous current collector. Here, the metal foil 100a may be formed of titanium.

However, a material of the metal foil 100a in the embodiment of the present invention is not limited thereto but may be any one or an alloy of two or more selected from aluminum, stainless steel, copper, nickel, titanium, tantalum and niobium.

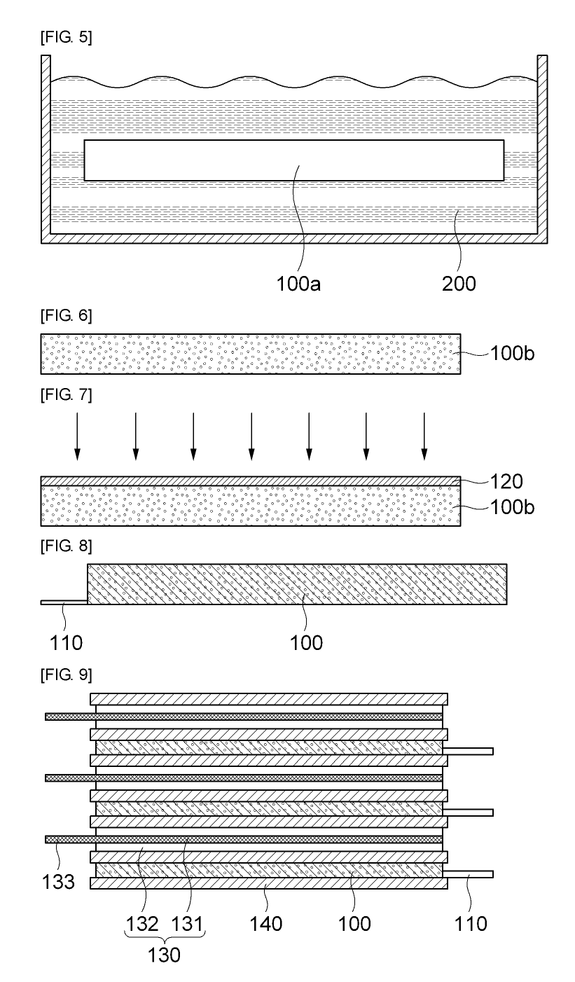

Referring to FIG. 5, the metal foil 100a is immersed in an acid solution 200 to form a porous current collector 100b having a plurality of pores and a skeleton structure as shown in FIG. 6.

Here, while the metal foil 100a is immersed in the acid solution, the plurality of pores may be formed in the metal foil 100a and simultaneously pitting may be formed in the skeleton structure that forms the pores. Here, formation of the pitting on the surface of the skeleton structure provides a surface roughness to the skeleton structure 101, increasing a surface area of the skeleton structure 101. Therefore, the bonding area between the skeleton structure 101 of the porous current collector 100b and the active material can be increased to enhance bonding strength between the porous current collector 100b and the active material.

The acid solution 200 may be formed by mixing different kinds of acids. Here, the different kinds of acids are mixed, the different kinds may explosively react with each other to etch the surface of the metal foil 100a, and thus, a plurality of pores 102 may be formed in the metal foil 100a and simultaneously the pitting may be formed in the skeleton structure 101 that forms the plurality of pores 102. Therefore, the skeleton structure 101 has a surface roughness to increase a surface area of the skeleton structure 101.

Here, the acid solution 200 may be a mixed solution of sulfuric acid and hydrochloric acid. The sulfuric acid and hydrochloric acid may be mixed at a ratio of 1:1 to 3:1. As described above, when the sulfuric acid and hydrochloric acid have the above mixing ratio, a reaction temperature of the solution is increased to a certain temperature, for example, 60° C. to 70° C., by an exothermic reaction of the sulfuric acid and hydrochloric acid, so that the pitting can be formed in the skeleton structure within several minutes. Here, when the mixing ratio of the sulfuric acid and hydrochloric acid is not in the above range, the pitting cannot be appropriately formed in the skeleton structure 101 and an ideal surface appearance cannot be implemented. In addition, a time for forming uniform and dense pitting may be increased to decrease productivity.

In addition, the acid solution 200 may be a mixed solution of hydrochloric acid and nitric acid. At this time, in consideration of a pitting formation time and level of the skeleton structure 101, the hydrochloric acid and nitric acid may be mixed at a ratio of 1:1 to 3:1.

Here, the surface roughness of the skeleton structure 101 can be formed by adjusting composition of the acid solution at a normal temperature without a separate heat treatment process, reducing process cost.

In addition, in order to remove the acid solution which may remain in the porous current collector 100b, a cleaning process of the porous current collector 100b and a dry process of drying a cleaning solution may be further performed. Here, the cleaning process may be performed by sequentially immersing the porous current collector 100b in acetone, ethyl alcohol and distilled water. At this time, in each step, an ultrasonic cleaner may be operated for at least 20 minutes.

Referring to FIG. 7, after forming the porous current collector 100b having a surface roughness, an active material 120 is applied on the porous current collector 100b. At this time, some of the active material 120 may be filled in bent portions and pores 102 of the porous current collector 100b.

The active material 120 may include active material particles, a conductive material, a binder and a solvent. Here, the active material particles may include a carbon material to which ions can be reversibly doped and undoped, i.e., activated carbon. In addition, the conductive material may be, for example, carbon black, a carbon fiber, graphite, and metal powder, and so on. Further, the binder may be, for example, polytetrafluoroethylene (PTFE), polyvinylidene fluoride (PVdF), polyimide, polyamideimide, polyethylene (PE), polypropylene (PP), carboxymethyl cellulose, stylene butadiene rubber (SBR), and so on.

Referring to FIG. 8, by pressing the porous current collector 100b including the active material applied thereof, the active material 120 can be uniformly permeated into the pores 120 of the porous current collector. Therefore, the electrode 100 including the active material uniformly contained in the porous current collector 100b may be formed.

The electrode 100 may include the active material filled in the porous current collector 100b to increase a contact area between the porous current collector 100b formed of a metal and the active material, enhancing conductivity of the electrode 100. Here, since the skeleton structure 101 has a surface roughness, the bonding area between the skeleton structure 101 and the active material can be increased. Therefore, since the bonding strength between the porous current collector and the active material can be improved to reduce a content of binder in the active material, a rate of utilization of the active material can be increased and lifespan characteristics of the charge/discharge cycle of the electrochemical capacitor can be improved.

In addition, as the active material is filled in the porous current collector, the thickness of the electrode 100 can be reduced while maintaining or increasing the capacity of the electrode 100, unlike the conventional art.

Referring to FIG. 8, a terminal 110 may be formed at one side of the electrode 100 to be electrically connected to an external power source. Here, a method of coupling the electrode 110 to the electrode 100 may be performed by welding.

Therefore, as the porous current collector in accordance with an exemplary embodiment of the present invention has the skeleton structure having a surface roughness, the bonding strength between the porous current collector and the active material can be further increased to improve a rate of utilization of the active material and cycle lifespan characteristics.

In addition, as the active material is filled in the current collector, the thickness of the electrode can be reduced while maintaining or increasing the capacity of the conventional electrode.

FIG. 9 is a cross-sectional view of an electrochemical capacitor in accordance with a second exemplary embodiment of the present invention. Here, the electrochemical capacitor includes the electrode manufactured according to the first embodiment.

Referring to FIG. 9, the electrochemical capacitor in accordance with a second exemplary embodiment of the present invention may include cathodes 100 and anodes 130 alternately laminated with separators 140 interposed therebetween.

The separators 140 may function to electrically separate the cathodes 100 and the anodes 130. While the separator 140 may be formed of, for example, paper, non-woven fabric, and porous cellulose-based resin, and so on, the material of the separator 140 in the embodiment of the present invention is not limited thereto.

The cathode 100 may include a cathode porous current collector and a cathode active material distributed in the cathode porous current collector. Here, the cathode porous current collector may include a skeleton structure that forms a plurality of pores. At this time, a plurality of pittings are formed in the surface of the skeleton structure to provide a surface roughness to the skeleton structure. The cathode active material may be filled in the pores in the cathode porous current collector and bonded to the skeleton structure of the cathode porous current collector. At this time, due to the surface roughness of the skeleton structure, the bonding area between the cathode active material and the cathode porous current collector can be increased. Therefore, since the bonding strength between the cathode active material and the cathode porous current collector can be increased to reduce a content of the binder in comparison with the conventional cathode active material, a contact resistance between the cathode porous current collector and the cathode active material can be reduced. In addition, the content of the binder of the cathode active material can be reduced to increase a content of the active material, instead of reduction in content of the binder, increasing the capacity of the cathode 100. Therefore, in order to increase the capacity of the cathode 100 in comparison with the anode 130, there is no need to increase the thickness of the cathode 100. This is because, when the electrochemical capacitor is a lithium ion capacitor, the capacity of the cathode 100 must be larger three to four times than that of the anode 130 so that the thickness of the cathode 100 must be increased.

The cathode porous current collector may be any one of titanium, aluminum, stainless steel, copper, nickel, tantalum and niobium.

In addition, the cathode active material may include activated carbon, a conductive material, a binder and solvent. Here, the conductive material may be, for example, carbon black, a carbon fiber, graphite, and metal powder, and so on. Further, the binder may be, for example, polytetrafluoroethylene (PTFE), polyvinylidene fluoride (PVdF), polyimide, polyamideimide, polyethylene (PE), polypropylene (PP), carboxymethyl cellulose, stylene butadiene rubber (SBR), and so on.

A cathode terminal 110 may be further installed at one side of the cathode 100 to be connected to an external power source. Here, the cathode terminal 110 may be connected to the cathode porous current collector by welding.

The anode 130 may include an anode current collector 131 and anode active material layers 132 disposed on both sides of the anode current collector 131.

The anode current collector 131 may include any one of metals, for example, copper, nickel and stainless steel. The anode current collector 131 may have a thin film shape, or may have a plurality of through-holes to effectively move ions and uniformly perform a doping process.

The anode active material layer 132 may include a carbon material that can be reversibly doped and undoped with lithium ions, i.e., graphite. In addition, the anode active material layer 132 may further include a binder and a conductive material.

Here, the anode 130 may include an anode terminal 133 to be connected to an external power source. At this time, the anode terminal 133 may extend from a portion of the anode current collector 131.

When the electrochemical capacitor is a lithium ion capacitor, lithium ions may be pre-doped to the anode 130. Therefore, energy density of the electrochemical capacitor can be increased.

While not shown, the laminated cathodes 100 and anodes 130 may be sealed by a housing and immersed in an electrolyte. Here, the electrolyte functions as a medium that can move ions. The electrolyte may include an electrolytic material and solvent. The electrolytic material may be a salt, for example, lithium salt, ammonium salt, or the like. The solvent may use non-proton organic solvent. The solvent may be selected in consideration of solubility of the electrolyte, reaction with the electrode, viscosity and a use temperature range. The solvent may be, for example, propylene carbonate, diethyl carbonate, ethylene carbonate, sulfolane, acetone nitrile, dimethoxy ethane, tetrahydrofurane, ethyl methyl carbonate, and so on. Here, solvent may be used by mixing one or two or more of the above.

The housing of the embodiment of the present invention may be formed by hot bonding two sheets of laminated films but may be limited to the material thereof.

Therefore, as described in the embodiment of the present invention, as the cathode can fill the cathode active material in the cathode porous current collector and form a surface roughness on the skeleton structure that forms pores of the cathode porous current collector, the bonding strength between the cathode porous current collector and the cathode active material can be increased to improve a rate of utilization of the cathode active material and charge/discharge cycle lifespan characteristics.

In addition, in this embodiment of the present invention, the bonding strength between the cathode porous current collector and the cathode active material can be increased and the content of the binder of the cathode active material can be reduced to decrease a contact resistance between the cathode porous current collector and the cathode active material.

Further, in this embodiment of the present invention, since the bonding strength between the cathode porous current collector and the cathode active material can be increased to enhance the capacity of the cathode, the thickness of the cathode can be reduced.

As can be seen from the foregoing, since the electrode for an electrochemical capacitor in accordance with an exemplary embodiment of the present invention is formed by permeating the active material into the porous current collector, conductivity of the electrode can be increased, high efficiency charge/discharge characteristics can be improved, and secession of the active material can be prevented to improve a rate of utilization of the active material.

In addition, since the electrode for an electrochemical capacitor in accordance with an exemplary embodiment of the present invention can form the porous current collector having the skeleton structure having a surface roughness to increase the bonding surface area between the porous current collector and the active material, a rate of utilization of the active material and cycle lifespan characteristics can be further improved.

Further, since the active material of the electrode for an electrochemical capacitor in accordance with an exemplary embodiment of the present invention is permeated into the current collector, the thickness of the electrode can be reduced in comparison with the conventional case of forming the electrode by forming the active material on the current collector.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A method of manufacturing an electrode for an electrochemical capacitor comprising:
immersing a metal foil in an acid solution to form a porous current collector having a skeleton structure with a surface roughness;
applying an active material on the porous current collector; and
pressing the porous current collector including the active material to distribute the active material into the porous current collector.

2. The method of manufacturing an electrode for an electrochemical capacitor according to claim 1, wherein the acid solution comprises different kinds of acids.

3. The method of manufacturing an electrode for an electrochemical capacitor according to claim 2, wherein the acid solution comprises a mixed solution of sulfuric acid and hydrochloric acid.

4. The method of manufacturing an electrode for an electrochemical capacitor according to claim 3, wherein the sulfuric acid and hydrochloric acid are mixed at a ratio of 1:1 to 3:1.

5. The method of manufacturing an electrode for an electrochemical capacitor according to claim 2, wherein the acid solution comprises a mixed solution of hydrochloric acid and nitric acid.

6. The method of manufacturing an electrode for an electrochemical capacitor according to claim 5, wherein the hydrochloric acid and nitric acid are mixed at a ratio of 1:1 to 3:1.

7. The method of manufacturing an electrode for an electrochemical capacitor according to claim 1, further comprising:
after immersing the metal foil in the acid solution to form the porous current collector having the skeleton structure with a surface roughness,
a cleaning process of removing the acid solution adsorbed to the porous current collector, and a dry process of removing a cleaning solution.

8. The method of manufacturing an electrode for an electrochemical capacitor according to claim 1, further comprising:
after pressing the porous current collector including the active material to distribute the active material into the porous current collector,
forming a terminal at one side of the porous current collector.

9. The method of manufacturing an electrode for an electrochemical capacitor according to claim 8, wherein forming the terminal at one side of the porous current collector is performed by welding.

10. The method of manufacturing an electrode for an electrochemical capacitor according to claim 1, wherein the active material comprises active material particles, a conductive material, a binder and solvent.

11. An electrochemical capacitor including cathodes and anodes alternately laminated with separators interposed therebetween,
wherein the cathode comprises a porous cathode current collector and a cathode active material filled in the porous cathode current collector, and
a skeleton that forms the porous cathode current collector has a surface roughness.

12. The electrochemical capacitor according to claim 11, further comprising:
a cathode terminal connected to the cathode current collector by welding.

13. The electrochemical capacitor according to claim 11, wherein the anode comprises an anode current collector and anode active material layers disposed on both surfaces of the anode current collector.

14. The electrochemical capacitor according to claim 13, further comprising:
an anode terminal extending from one side of the anode current collector.
